(19) United States
(12) Patent Application Publication
(10) Pub. No.: US 2024/0166479 A1
(43) Pub. Date: May 23, 2024

(54) METHOD FOR MONITORING THE OPERATION OF A WINCH, AND IN PARTICULAR THE NUMBER OF WINDING LAYERS OF A CABLE ON A WINCH DRUM

(71) Applicant: MANITOWOC CRANE GROUP FRANCE, DARDILLY (FR)

(72) Inventors: Frédéric LARGY, SAINT GEORGES SUR RENON (FR); Thibaud LAURETTI, RENAISON (FR); Nicolas NEVERS, SAINT-POURCAIN-SUR BRESBE (FR)

(21) Appl. No.: 18/518,220

(22) Filed: Nov. 22, 2023

(30) Foreign Application Priority Data
Nov. 22, 2022 (FR) 2212141

(51) Int. Cl. B66D 1/48; B66C 13/16; B66C 13/46; B66C 23/82; B66C 23/88

(52) U.S. Cl. CPC B66D 1/485; B66C 13/16; B66C 13/46; B66C 23/82; B66C 23/88

(57) ABSTRACT

A method for monitoring operation of a winch having a motor driving a drum on which a cable is wound, the cable being able to be wound on several winding layers whose number varies depending on the winding and unwinding of the cable, the method implementing continuous monitoring of the number of winding layers of the cable on the drum while ensuring in real time at least the following steps: measuring a first parameter (P1) representative of a linear travel speed of the cable leaving the drum; measuring a second parameter (P2; P2′) representative of a rotation speed of the drum; and determining the number of winding layers of the cable depending on the first parameter and the second parameter. This method may find an advantageous application in the monitoring of winches of lifting device, and in particular cranes.

### TECHNICAL FIELD

The invention relates to a method for monitoring the operation of a winch, implementing a continuous monitoring of the number of winding layers of a cable on a drum of the winch.

The invention finds a preferred, and non-limiting, application for a crane-type lifting device, and in particular a tower crane, an element-mounted crane, an automated mounting crane, a port crane and a movable crane. The invention can also be applied to a cable transport device, such as for example a cable car or a chairlift.

### STATE OF THE ART

In an application to a lifting device, such as a crane, it is known to use a lifting winch comprising a motor rotatably driving a drum on which a cable, called a lifting cable, is wound, to displace a suspended load on a hook secured to the cable, to raise and lower it. It is also to use a distribution winch comprising a motor rotatably driving a drum on which a cable, called a distribution cable, is wound, to displace in translation a distributor trolley along a boom, the lifting cable passing through this distributor trolley so that the load is suspended below the distributor trolley which thus ensures a displacement of the load along the boom.

It is also known, in a luffing boom crane, to use a luffing winch comprising a motor rotatably driving a drum on which a cable is wound, called a luffing cable, which is connected to the boom to raise or lower thereof this in order to tilt it more or less between a lowered horizontal position and several raised positions.

Conventionally, the drum is driven by the motor via a reduction gear.

Generally, the cable can be wound on its drum on several winding layers, whose number varies depending on the winding and unwinding of the cable; it is then a multi-layer drum.

There is a need to monitor the operation of a winch, in order to know, for example, the length of the unwound or wound cable, a load indicator, or the level of damage to the cable in order to anticipate its replacement.

### SUMMARY OF THE INVENTION

To this end, the invention proposes to increase reliability or improve this monitoring of the winch by focusing on a parameter which is the number of winding layers of the cable on the drum.

Thus, the invention proposes a method for monitoring the operation of a winch, this winch comprising a motor driving a drum on which a cable is wound, this cable being able to be wound on the drum on several winding layers whose number varies depending on the winding and unwinding of the cable, wherein the number of winding layers of the cable can take different values between 1 and N, N being the maximum number of winding layers of the cable.

This method implements a continuous monitoring of the number of winding layers of the cable on the drum by ensuring in real time at least the following steps of: measuring a first parameter representative of a linear travel speed of the
measuring a second parameter representative of a drum rotation speed; cable leaving the drum;
determining the number of cable winding layers based on the first parameter and the second parameter;
logging in a database, over a given period of time, of values of the number of winding layers which are associated with layer numbers, to establish specific cumulative durations of use specific to each layer number.

Such a method thus makes it possible to know in real time the number of winding layers of the cable on the drum, and therefore equivalently the winding layer in use, which is an advantageous and useful information for improving the precision in the estimation of numerous parameters, such as a length of unwound or wound cable, a height under load, a load indicator, a cable winding fault on the drum, etc.

This method is based on the following approach:
measuring the first parameter making it possible to deduce the linear travel speed of the cable;
measuring the second parameter making it possible to deduce the rotation speed of the drum;
establishing the number of winding layers of the cable, which is linked to the winding radius of the cable on the drum, this winding radius itself being a function of the linear travel speed of the cable and the rotation speed of the drum.

Moreover, the logging makes it possible to know for how long the cable has occupied zero layers, one layer, two layers, etc. up to N layers, which is particularly useful for estimating whether the deepest layers (layers 1 and 2 at least) have been reached and therefore determine a level of stress or use of the cable termination attached to the drum; it is called a dead cable part for the end part of the cable which is not stressed or used.

According to one feature, measuring the first parameter consists in measuring a rotation speed of a pulley on which the cable circulates at the outlet of the drum, the linear travel speed of the cable being deduced as a function of this rotation speed of the pulley and of a geometry of the pulley.

The rotation speed of the pulley carrying the cable can for example be measured using a tachymetric system (optical, mechanical, inductive, or other).

According to another feature, measuring the second parameter consists in a direct measurement of the rotation speed of the drum or in a measurement of an output speed of the motor.

The rotation speed of the drum or the output speed of the motor can for example be measured using a tachymetric system (optical, mechanical, inductive, or other).

According to one possibility, the method implements a calculation of the linear travel speed of the cable as a function of the first parameter, and a calculation of the rotation speed of the drum as a function of the second parameter, and the number of winding layers of the cable is determined based on a ratio between the linear travel speed of the cable and the rotation speed of the drum.

Indeed, this ratio between the linear travel speed of the cable and the rotation speed of the drum is proportional to the radial distance (or winding diameter) of the cable.

According to another possibility, the method implements a determination of a length of unwound or wound cable as a function of the number of winding layers of the cable and a reference position.

Indeed, knowing the number of winding layers of the cable improves the precision in estimating such a length.

Advantageously, the method implements an estimation of a damage index for the cable based on the cumulative durations of use specific to each layer number.

Indeed, if the deep layers are not enough stressed or used, then there is a situation of potential damage for the dead cable part; and therefore such a damage index is particularly advantageous for anticipating and managing a risk linked to this damage of the dead cable part.

In a particular embodiment, the damage index is classified as critical when at least one of the cumulative durations of use is less than a critical threshold over the given period of time.

According to a possibility, an alarm is generated when the damage index is classified as critical; so as to alert an operator or manager that it is time to audit or even replace the cable.

An intermediate threshold can be provided, higher than the critical threshold, to inform that the cable must be completely unwound in order to stress the dead cable part, and therefore prevent critical damage.

In a particular embodiment, the method implements a monitoring of an angular position of the drum.

Such monitoring has two main interests:
a determination of a number of coils of the cable as a function of the number of winding layers of the cable and the angular position of the drum; and/or
a detection of a cable winding fault depending on the number of winding layers of the cable and the angular position of the drum.

In a preferred, and non-limiting, application, the winch is a lifting winch of a lifting device, such as for example a crane, in order to lift/lower a load suspended from a hook fixed on the cable, or the winch is a luffing winch of a lifting device of the luffing boom crane type, to tilt a boom more or less in order to lift/lower a load suspended from a hook fixed on the boom.

It should be noted that such a luffing winch can also make it possible to displace the load along the boom, on this type of luffing boom crane.

According to one possibility linked to the lifting winch and to the luffing winch, the method implements a determination of a height under the hook, corresponding to a vertical distance between the hook and the ground on which the lifting device rests, said height under hook being determined continuously as a function of the number of winding layers

According to another possibility linked to the lifting winch and the luffing winch, the method implements a determination of a load indicator which is representative of a weight of the load, said load indicator being determined continuously as a function of the number of winding layers.

The invention also relates to a monitoring system for monitoring the operation of a winch, the winch comprising a motor driving a drum on which a cable is wound, said cable being able to be wound on said drum on several winding layers whose number varies depending on the winding and unwinding of the cable, this monitoring system implementing a continuous monitoring of the number of winding layers of the cable on the drum by means of:
a first measuring device configured for measuring a first parameter representative of a linear travel speed of the cable leaving the drum;
a second measuring device configured for measuring a second parameter representative of a rotation speed of the drum;
a calculation unit configured for determining the number of cable winding layers as a function of the first parameter and the second parameter;
   and wherein the calculation unit is configured to implement a logging in a database, over a given period of time, of values of the number of winding layers which are associated with layer numbers, to establish specific cumulative durations of use specific to each layer number.

The invention also concerns a lifting device, such as for example a crane, comprising:
a lifting winch comprising a motor driving a drum on which is wound a lifting cable connected to a hook for lifting/lowering a load suspended from this hook, this lifting cable being able to be wound on said drum on several winding layers whose number varies depending on the winding and unwinding of the lifting cable, or
a luffing winch comprising a motor rotatably driving a drum on which is wound a luffing cable which is connected to a boom to raise or lower the latter in order to lift/lower a load suspended from a hook fixed on the boom;

and wherein this lifting device comprises a monitoring system as described above for monitoring the operation of said lifting winch or said luffing winch.

### BRIEF DESCRIPTION OF THE FIGURES

Other characteristics and advantages of the present invention will appear on reading the detailed description below, of a non-limiting implementation example, made with reference to the appended figures wherein:

FIG. 1 is a schematic view of a winch and a monitoring system for monitoring the operation of the winch;

FIG. 2 is a schematic view from two distinct angles of a drum for illustrating the winding layers of a cable;

FIG. 3 is a schematic view of two lifting devices equipped with winches suitable for implementing a monitoring method.

### DETAILED DESCRIPTION OF ONE OR MORE EMBODIMENTS OF THE INVENTION

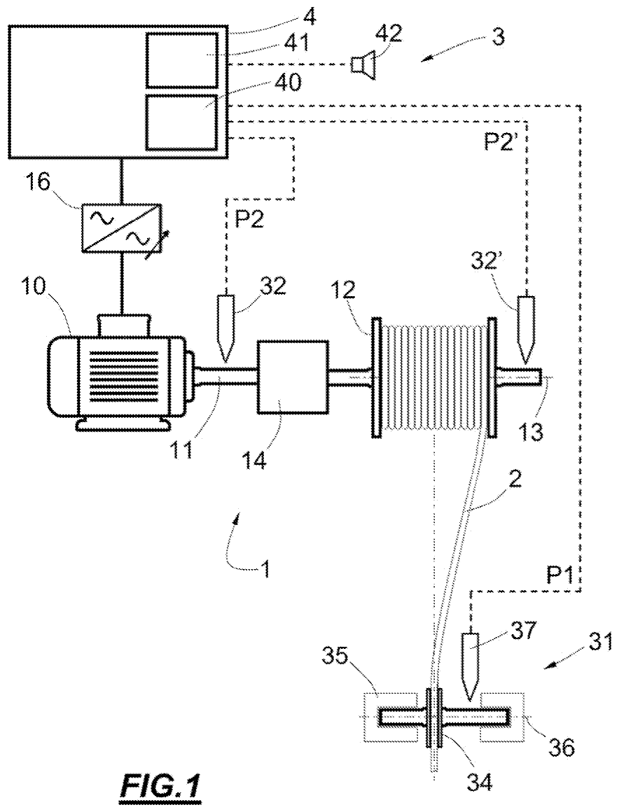

With reference to FIG. 1, a winch 1 adapted for the implementation of a monitoring method comprises:
a motor 10 which is a rotary motor provided with a motor shaft 11 rotatably driven;
a drum 12, of the multi-layer drum type, rotatably mounted on a frame about a drum axis 13, said drum 12 being coupled to the motor shaft 11 to be rotated by the motor 10 about its drum axis 13.

The drum 12 can be coupled to the motor shaft 11 via a reduction gear 14 to modify the speed ratio and/or the torque between the motor shaft 11 and the drum 12.

The motor 10 can be driven by a control/command system 4 (such as for example a system integrating at least a processor and/or a controller and/or an electronic card) via a speed variator 16 (also called frequency variator) designed to regulate the speed of the motor 10.

A cable 2 is wound on the drum 12, this cable 2 being able to be wound on the drum 12 on several winding layers, whose number varies depending on the winding and unwinding of the cable 2. The number of winding layers of the cable 2 can take different values comprised between 1 and N, N being the maximum number of winding layers of the cable 2. Thus, when the cable 2 is wound to its maximum, the number of winding layers is N.

The values of the number of winding layers are thus associated with layer numbers. In other words, when the cable 2 is wound to its maximum, it is wound on N layers comprising a layer no. 1 (the deepest layer or closest to the drum axis 13, which is in contact with the drum 12), then a layer no. 2 (in contact with the layer no. 1), then a layer no. 3, and so on until the layer no. N (the layer farthest from the axis of drum 13). The layer no. 1 thus corresponds to the visible layer when the cable 2 is unwound almost to its maximum (the maximum of the unwinding corresponding to the scenario normally never reached where there is no more layer and only one end of the cable is attached to the drum); and the layer no. N thus corresponds to the layer visible when the cable 2 is wound to its maximum.

On each layer, the number of coils or turns of the cable 2 can be substantially equivalent, which depends on the length of the drum 12 and the diameter of the cable 2.

Moreover, each winding layer of the cable 2 is associated with a radial distance (or layer radius) measured from the drum axis 13 to the center of the cable 2 in the layer; the radial distance therefore increasing with the number of the layer.

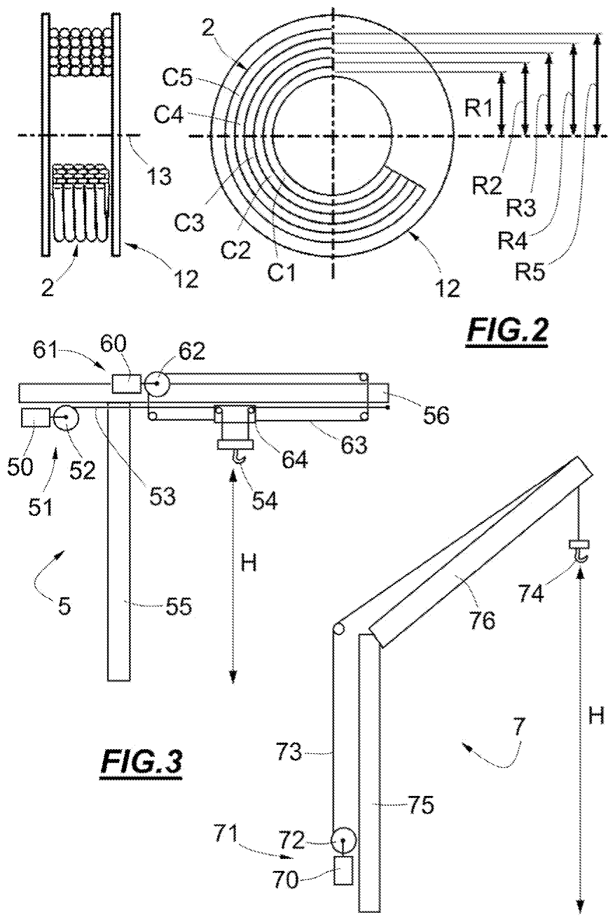

FIG. 2 illustrates an example of drum 12 around which five winding layers of the cable 2 are wound, with a layer C1 or layer n°1 associated with a radial distance R1, a layer C2 or layer n°2 associated with a radial distance R2, a layer C3 or layer n°3 associated with a radial distance R3, a layer C4 or layer n°4 associated with a radial distance R4, and a layer C5 or layer n°5 associated with a radial distance R5.

A monitoring system 3 is provided to monitor the operation of the winch 1, and more precisely to implement a continuous (or real-time) monitoring of the number of winding layers of the cable 2 on the drum 12.

This monitoring system 3 comprises:
a first measuring device 31 configured for measuring a first parameter P1 representative of a linear travel speed of the cable 2 at the outlet of the drum 12;
a second measuring device 32 or 32′ configured for measuring a second parameter P2 or P2′ representative of a rotation speed of the drum 12 about its drum axis 13; and
a calculation unit 40 configured for determining the number of winding layers of the cable 2 as a function of the first parameter P1 and the second parameter P2.

In the illustrated example, the calculation unit 40 is integrated into the control/command system 4 which drives the motor 10. In other words, the control/command system 4 comprises calculation means adapted to form the calculation unit 40 which determines the number of winding layers of the cable 2. It is of course possible that the calculation unit 40 is distinct from the control/command system 4.

The first measuring device 31 may comprise:
a pulley 34 on which the cable 2 circulates at the outlet of the drum 12, where the pulley 34 is rotatably mounted on a fixed support 35 so that the pulley 34 rotates about a pulley axis 36 under the effect of the travel of the cable 2; and
a tachymetric system 37 (or tachometer) adapted to measure the rotation speed of the pulley 33.

Indeed, the rotation speed of the pulley 34 is directly linked to the linear travel speed of the cable 2 at the outlet of the drum 12, according to a linear law which depends on the diameter of the pulley 34. The tachymetric system 37 can for example be present in the form of an optical tachometer, mechanical or contact tachometer, inductive tachometer, or other device for measuring a rotation speed. Thus, with this first measuring device 31, the first parameter P1 corresponds to the rotation speed of the pulley 34.

In a first embodiment, the second measuring device 32 is in the form of a tachymetric system (or tachometer) adapted to measure an output speed of the motor 10, in other words a rotation speed of the motor shaft 11. This output speed of the motor 10 corresponds to the rotation speed of the drum 12, either directly or after taking into account the reduction ratio of the reduction gear 14. Thus, with this second measuring device 32, the second parameter P2 corresponds to the output speed of the motor 10.

In a second embodiment, the second measuring device 32′ is in the form of a tachymetric system (or tachometer) adapted to directly measure the rotation speed of the drum 12. Thus, with this second measuring device 32′, the second parameter P2′ corresponds to the rotation speed of the drum 12.

It is of course possible to use both the second measuring device 32 and the second measuring device 32′ to have a redundancy in the measurement.

Thus, the calculation unit 40 implements:
a calculation of the linear travel speed of the cable 2 as a function of the first parameter P1;
a calculation of the rotation speed of the drum 12 as a function of the second parameter P2 or P2′, and
a calculation of the number of winding layers of the cable 2 as a function of a ratio between the linear travel speed of the cable 2 and the rotation speed of the drum 12.

Indeed, the number of winding layers of the cable 2 (or the number of the layer being wound or unwound) is linked to the winding radius of the cable 2 on the drum 12, which corresponds to the radial distance of the most external layer (which is the layer being wound or unwound, furthest from the drum axis 13), and this winding radius is itself a function of the linear travel speed of the cable 2 and the rotation speed of the drum 12. In the example of FIG. 2, the winding radius corresponds to the radial distance R5 of the layer C5 or layer n°5.

More precisely, the ratio between the linear travel speed of the cable 2 (expressed in meters per second) and the rotation speed of the drum 12 (expressed in radians per second) is equivalent to this winding radius (expressed in meters) of the cable 2 on the drum 12.

After calculating this number of winding layers of the cable 2, the calculation unit 40 can for example implement:
a determination of a length of unwound or wound cable as a function of the number of winding layers of the cable 2 and a reference position; and/or
a detection of a change in the number of winding layers of the cable 2, namely the transition from a layer no. K to a layer no. (K−1) when the cable 2 is unwound and the passage from a layer no. K to a layer no. (K+1) when the cable 2 is wound.

The calculation unit 40 can implement:
a logging in a database 41, over a given period of time, the values of the number of winding layers which are associated with layer numbers, to establish cumulative durations of use specific to each layer number;
an estimate of a damage index for the cable 2 based on the cumulative durations of use specific to each layer number; and
a classification of this damage index as critical when at least one of the cumulative durations of use is less than a critical threshold over the given period of time.

In the illustrated example, the database 41 is integrated into the control/command system 4. In other words, the control/command system 4 comprises an inner memory adapted to form the database 41. It is of course possible that the database 41 is deported from the control/command system 4.

The method can implement the generation of an alarm (or alarm signal) when the damage index is classified as critical. Thus, a warning device 42 is provided, which can be visual or audible, connected to the calculation unit 40 and/or to the control/command system 4, to be driven in order to generate a visual or audible alarm, when the damage index is classified as critical.

The calculation unit 40 can implement:
a monitoring of an angular position of the drum 12, for example by means of the second measuring device 32′;
a determination of a number of coil of the cable 2 as a function of the number of winding layers of the cable and the angular position of the drum 12;
a detection of a winding fault of the cable 2 as a function of the number of winding layers of the cable 2 and the angular position of the drum 12.

FIG. 3 illustrates a first lifting device 5 of the tower crane type, comprising a mast 55 at the top of which is mounted a boom 56 which can rotate about a vertical axis, and also comprising:
a lifting winch 51 comprising a motor 50 rotatably driving a drum 52 on which is wound a lifting cable 53 connected to a hook 54 to lift/lower a load suspended from this hook 54 to raise and lower it; and
a distribution winch 61 comprising a motor 60 rotatably driving a drum 62 on which a distribution cable 63 is wound to displace in translation a distributor trolley 64 along the arrow 56, the lifting cable 53 passing through this distributor trolley 64 so that the load is suspended below the distributor trolley 64 which thus ensures a displacement of the load along the boom 56.

FIG. 3 illustrates a second lifting device 7 of the luffing boom crane type, comprising a mast 75 at the top of which is mounted a boom 76 which can pivot about a horizontal axis so that this boom can be more or less inclined relative to the horizontal and can thus be raised, and this second lifting device 7 comprises a luffing winch 71 comprising a motor 70 rotatably driving a drum 72 on which is wound a luffing cable 73 which is connected to the boom 76 to raise or lower it in order to tilt it more or less between a lowered horizontal position and several raised positions, and thus to lift/lower a load suspended from a hook 74 fixed on the boom 76. It will be noted that such a luffing winch 71 can possibly also make it possible (by unwinding/winding the luffing cable 73) to also displace the load along the boom 76, on this type of luffing boom crane.

The monitoring system 3 previously described can be implemented to:
monitor the operation of the lifting winch 51, and more precisely to implement continuous (or real-time) monitoring of the number of winding layers of the lifting cable 53 on the drum 52; or
monitor the operation of the distribution winch 61, and more precisely to implement continuous (or real-time) monitoring of the number of winding layers of the distribution cable 63 on the drum 62; or
monitor the operation of the luffing winch 71, and more precisely to implement continuous (or real-time) monitoring of the number of winding layers of the luffing cable 73 on the drum 72.

In the case of a monitoring of the lifting winch 51 or the luffing winch 71, the number of winding layers of the lifting cable 53 or the luffing cable 73 allows a determination, by the calculation unit 40, of a height under hook H, corresponding to a vertical distance between the hook 54 or 74 and the ground on which the lifting device 5 or 7 rests. In other words, the calculation unit 40 can continuously determine this height under hook H depending on the number of winding layers.

In the case of a monitoring of the lifting winch 51 or the luffing winch 71, the number of winding layers of the lifting cable 53 or the luffing cable 73 allows a determination, by the calculation unit 40, of a load indicator which is representative of a weight of the load suspended from the hook 54 or 74. In other words, the calculation unit 40 can continuously determine this load indicator as a function of the number of winding layers.

1-17. (canceled)

18. A method for monitoring the operation of a winch, said winch comprising a motor driving a drum on which a cable is wound, said cable being able to be wound on said drum on several winding layers whose number varies depending on the winding and unwinding of the cable, wherein the number of winding layers of the cable can take different values between 1 and N, N being the maximum number of winding layers of the cable, said method implementing a continuous monitoring of the number of winding layers of the cable on the drum by ensuring in real time at least the following steps:
measuring a first parameter (P1) representative of a linear travel speed of the cable at the outlet of the drum;
measuring a second parameter (P2; P2′) representative of a rotation speed of the drum;
determining the number of winding layers of the cable as a function of the first parameter (P1) and the second parameter (P2; P2′); and
logging in a database, over a given period of time, of values of the number of winding layers which are associated with layer numbers, to establish specific cumulative durations of use specific to each layer number.

19. The method according to claim 18, wherein measuring the first parameter (P1) consists in measuring a rotation speed of a pulley on which the cable circulates at the outlet of the drum, the linear travel speed of the cable being deduced as a function of this rotation speed of the pulley and of a geometry of the pulley.

20. The method according to claim 18, wherein measuring the second parameter consists in a direct measurement of the rotation speed of the drum or in a measurement of an output speed of the motor.

21. The method according to claim 18, wherein the method implements a calculation of the linear travel speed of the cable as a function of the first parameter (P1), and a calculation of the rotation speed of the drum as a function of the second parameter (P2; P2′), and the number of winding layers of the cable is determined as a function of a ratio between the linear travel speed of the cable and the rotation speed of the drum.

22. The method according to claim 18, wherein the method implements a determination of a length of unwound or wound cable as a function of the number of winding layers of the cable and a reference position.

23. The method according to claim 18, wherein the method implements a detection of a change in the number of winding layers of the cable.

24. The method according to claim 18, wherein the method implements an estimation of a damage index for the cable as a function of the cumulative durations of use specific to each layer number.

25. The method according to claim 24, wherein the damage index is classified as critical when at least one of the cumulative durations of use is less than a critical threshold over the given period of time.

26. The method according to claim 25, wherein an alarm is generated when the damage index is classified as critical.

27. The method according to claim 18, wherein the method implements a monitoring of an angular position of the drum.

28. The method according to claim 27, wherein the method implements a determination of a number of coils of the cable as a function of the number of winding layers of the cable and the angular position of the drum.

29. The method according to claim 27, wherein the method implements a detection of a winding fault of the cable as a function of the number of winding layers of the cable and the angular position of the drum.

30. The method according to claim 18, wherein the winch is a lifting winch of a lifting device, such as for example a crane, in order to lift/lower a load suspended from a hook fixed on the cable, or the winch is a luffing winch of a lifting device of the luffing boom crane type, to tilt a boom more or less in order to lift/lower a load suspended from a hook attached to the boom.

31. The method according to claim 30, wherein the method implements a determination of a height under the hook (H), corresponding to a vertical distance between the hook and the ground on which the lifting device rests, said height under hook (H) being determined continuously as a function of the number of winding layers.

32. The method according to claim 30, wherein the method implements a determination of a load indicator which is representative of a weight of the load, said load indicator being determined continuously as a function of the number of winding layers.

33. A monitoring system for monitoring the operation of a winch, said winch comprising a motor driving a drum on which a cable is wound, said cable being able to be wound on said drum on several winding layers whose number varies depending on the winding and unwinding of the cable, said monitoring system implementing a continuous monitoring of the number of winding layers of the cable on the drum by means of:
a first measuring device configured for measuring a first parameter (P1) representative of a linear travel speed of the cable at the outlet of the drum;
a second measuring device configured for measuring a second parameter (P2; P2′) representative of a rotation speed of the drum; and
a calculation unit configured for determining the number of winding layers of the cable as a function of the first parameter (P1) and the second parameter (P2; P2′); and wherein the calculation unit is configured to implement a logging in a database, over a given period of time, of values of the number of winding layers which are associated with layer numbers, to establish specific cumulative durations of use specific to each layer number.

34. A lifting device, comprising:
a lifting winch comprising a motor driving a drum on which is wound a lifting cable connected to a hook to lift/lower a load suspended from this hook, said lifting cable being able to be wound on said drum on several winding layers whose number varies depending on the winding and unwinding of the lifting cable, or
a luffing winch comprising a motor rotatably driving a drum on which is wound a luffing cable which is connected to a boom to raise or lower the latter in order to lift/lower a load suspended from a hook fixed on the boom;
and wherein said lifting apparatus comprises a monitoring system according to claim 33 for monitoring the operation of said lifting winch or said luffing winch.
